(19) United States
(12) Patent Application Publication
(10) Pub. No.: US 2015/0158112 A1
(43) Pub. Date: Jun. 11, 2015

(54) METHOD FOR SEALING TWO ELEMENTS BY LOW TEMPERATURE THERMOCOMPRESSION

(71) Applicant: COMMISSARIAT A L'ENERGIE ATOMIQUE ET AUX ENE ALT, Paris (FR)

(72) Inventor: Arnaud GARNIER, Grenoble (FR)

(73) Assignee: COMMISSARIAT A L'ENERGIE ATOMIQUE ET AUX ENE ALT, Paris (FR)

(21) Appl. No.: 14/626,469

(22) Filed: Feb. 19, 2015

Related U.S. Application Data
(62) Division of application No. 13/165,034, filed on Jun. 21, 2011.

(30) Foreign Application Priority Data
Jun. 23, 2010 (FR) 10 55014

(51) Int. Cl. B23K 20/02; B23K 20/00

(52) U.S. Cl. CPC B23K 20/023; B23K 20/002

(57) ABSTRACT

A sealing method between two elements includes producing a first sealing material on a face of a first of the two elements, producing a second sealing material, different from the first sealing material, on one face of a second of the two elements, securing the two elements by thermocompression of the sealing materials against each other at a temperature Tc below the melting temperatures of the first and second sealing materials, the first and second sealing materials are chosen such that they each have at least one phase able to react with the phase of the other sealing material by interdiffusion of the components of the phases of the sealing materials during the securing step and forming at least one other solid phase having a melting temperature above the temperature Tc.

### TECHNICAL FIELD

The invention relates to the field of the assembly of two elements. The assembly in particular relates to sealing between two substrates via sealing materials. The method is also well suited to produce a hermetic seal during packaging of microsystems such as MEMS and/or NEMS devices, or during the production of 3D interconnections.

### BACKGROUND OF THE INVENTION

Several techniques exist for producing sealing between two substrates, for example during packaging of a microelectronic device such as a MEMS, in order to guarantee the tightness of a cavity formed between these two substrates in which the device is intended to be encapsulated.

It is for example possible to produce molecular sealing by direct adhesion of the two substrates. In that case, the surfaces to be adhered must be planar and fairly smooth (e.g.: roughness RMS<0.5 nm in AFM (atomic force microscopy) 5×5 μm²), therefore requiring the implementation of specific surface preparation steps. This type of seal is also very sensitive to particulate contamination, which makes it difficult to implement it for packaging microsystems including freed structures not tolerating liquid chemical cleaning.

It is also possible to produce anodic sealing, also called anodic bonding, between the two substrates. This type of sealing is generally limited to the assembly of a glass substrate with a silicon substrate. It requires the application of a voltage in the vicinity of several hundred volts between the substrates, which is incompatible with many microelectronic applications.

It is also possible to produce eutectic metal sealing or TLP (Transient Liquid Phase) sealing between the two substrates. In the case of eutectic metal sealing, each substrate is covered with a sub-layer intended to be secured to the sub-layer of the other substrate via a metal braze. A thermal treatment at a temperature higher than the melting temperature of the metal alloy for forming the braze makes this alloy switch to the liquid phase. This liquid phase must wet the sub-layers on which it is initially positioned well. In the case of TLP sealing, the composition of the alloy of the braze evolves during the transition, or switching, through the liquid phase (by solid-liquid diffusion) and the melting temperature of the material evolves, while the temperature according to the method can remain constant. There is then isothermal solidification. In both cases (eutectic metal sealing and TLP sealing), the necessary passage through a liquid phase of the braze has several drawbacks:
it limits the dimensional stability of the stack, and in particular the spacing between the substrates,
it can create holes in the alloy after sealing (for example in the case of very rapid isothermal solidification (shrinkage) and in the presence of stops),
it favors the desorption of impurities during the liquid phase transition, which can deteriorate the vacuum in the cavity,
it can create short circuits by run-out of the alloy if metal connections are located nearby.

The sealing can also be done by thermocompression. In this case, the surfaces to be adhered must be free of oxide and relatively smooth, and the underlying materials fairly ductile at the chosen sealing temperature. This type of sealing, whether chip-on-wafer or wafer-on-wafer of the Au/Au, Cu/Cu or Al/Al type, has several constraints:
the heat balances to be applied are relatively high, and for example between 260° C. and 450° C. for a period between 1 minute and 90 minutes for gold, or between 300° C. and 400° C. for a period of 30 minutes for copper, or equal to 450° C. for aluminum,
the real pressure applied to the surfaces to be adhered is relatively high, i.e. between 0.4 MPa and around one hundred MPa, knowing that the greater the roughness of the surfaces to be adhered, the higher the pressure to be applied,
it is necessary for the roughnesses of the surfaces to be sealed to be relatively low, for example below 3 nm measured in AFM 5×5 μm² scan,
a suitable surface preparation must be done to cleanse and/or deoxidize the surfaces to be sealed: in the case of gold/gold sealing, the surfaces can be cleansed for organic contamination with UV-ozone for 90 minutes, or with H₂O:H₂O₂:NH₄OH (60:12:1) at a temperature of 70° C. for 10 minutes or with H₂SO₄:H₂O₂ (1:1) for 1 minute; in the case of copper/copper sealing, the surfaces are deoxidized with HCl; in the case of aluminum, the affinity of the aluminum with the oxygen from the air imposes a deoxidization before sealing, as well as very constrictive deoxidization-sealing chaining.

It is therefore possible to see that each sealing method has drawbacks.

Some microsystems require hermetic packaging that should preferably be done by metal sealing for the following reasons:
better theoretical tightness,
possibility of electrical communication between the substrates to be adhered,
no need to apply high voltages able to deteriorate the devices to be encapsulated, unlike anodic sealing,
no systematic use of glass covers, unlike with anodic sealing,
no strong stresses on the roughness and particulate contamination of the surface, unlike molecular adhesion.

However, it is sometimes preferable to avoid performing metal sealing due to the switching into the liquid phase of the braze for the following reasons:
space between the substrates to be adhered (without adding stops, which makes the technology more complex) difficult to control,
the transition in liquid phase is of a nature to cause the desorption of gas captured in the metal or metal alloy (in particular after an electrolytic deposition where H₂ is in particular found in the deposited materials),
difficulty of mastering the chemical compositions of the alloys and sealing temperatures on the whole of the surfaces to be adhered (particularly on wafers with a 200 mm diameter); in this case, it is necessary to increase the sealing temperature to ensure that the alloy has indeed switched to the liquid phase, which is not desirable if the heat balance of the devices to be assembled is limited and close to the sealing heat balance,
difficult to prevent potential short circuits with the elements of the chip.

### BRIEF DESCRIPTION OF THE INVENTION

Thus there is a need to propose a new sealing method not having the drawbacks of the sealing methods of the prior art.

To that end, one embodiment proposes a sealing method between at least two elements, including at least the following steps:
producing at least one first sealing material on at least one face, or surface, of a first of said two elements,
producing at least one second sealing material, different from the first sealing material, on at least one face of a second of said two elements,
securing said two elements by thermocompression of the sealing materials one against the other at a temperature Tc below the melting temperatures of the first and second sealing materials,

wherein the first and second sealing materials are chosen such that they each have at least one phase able to react with the phase of the other sealing material by interdiffusion of the components of the phases of the sealing materials during the securing step.

During the step of securing, the phases of the sealing materials can react together and form at least one other solid phase, the melting temperature of which is higher than the temperature Tc.

The sealing method proposes to perform thermocompression of two sealing materials at a temperature below the melting temperatures of these sealing materials, which represents a low heat balance relative to the sealing methods of the prior art. Thus, the first sealing material and/or the second sealing material does not switch to the liquid phase, but softens, i.e. becomes relatively softer, which makes it possible to implement the thermocompression at relatively low pressures without worrying about any roughness on the surfaces of the sealing materials, or needing to cleanse or deoxidize the surfaces to be sealed. Given that the roughness of the sealing materials is not significant here, the sealing method does not require the implementation of additional steps for planarizing the sealing materials.

During the implementation of this sealing method, the softening of at least one of the sealing materials at a sealing temperature e.g. close to the melting temperature makes it possible, owing to the mechanical pressure applied between the two elements, to deform the softened sealing material(s), to ultimately ensure good contact between the two surfaces to be adhered, favoring the reaction by interdiffusion between the two sealing materials allowing adhesion between the two elements.

Furthermore, no chemical surface treatment is required to remove any thin oxide layer formed on the surface of the sealing materials, as it is possible to keep this potential thin oxide layer. Such an oxide layer, for example tin-based, can for example appear on the surface of a first sealing layer formed by the Au₅Sn and AuSn phases. The securing of this first sealing material is compatible with a layer of gold, forming the second sealing material, which does not oxidize. Furthermore, given that the sealing materials do not switch to a liquid phase, the thermocompression does not cause run-out, which prevents the risk of short circuit, and the spacing between the sealed elements is controlled. Lastly, the sealing thus done offers very good mechanical strength of the sealed elements.

The tightness obtained with this new sealing method is also very good. For example, in the case of a substrate having a membrane forming the cover of a cavity secured to another substrate using the method, deflection measurements of the membrane in a controlled atmosphere made it possible to observe no deflections of the membrane over time. This tightness in particular comes from the fact that the sealing phase formed has very few pores after implementing the sealing method.

The term “phase” designates an alloy, or a pure body, that is chemically and physically homogenous, i.e. in which the physical and chemical parameters vary continuously, that is linearly.

The sealing materials may be pure metal materials, such as gold, tin, copper, aluminum, etc. In one alternative, the sealing materials may be homogenous or non-homogenous metal alloys, for example AuSn, Au₅Sn, AuIn, etc. “Homogenous alloy” refers to an alloy having a single phase, and “non-homogenous alloy” refers to an alloy having several mixed or superimposed phases (for example AuSn+Au₅Sn). It is also possible for one of the sealing materials to be a pure metal and the other sealing material to be an alloy.

During the securing step, the phases of sealing material may react together to form at least one other phase. In this case, this other phase is solid and has a melting temperature higher than the temperature Tc. In this way, during thermocompression, none of the phases present between the two elements to be sealed is in liquid state, which makes it possible to avoid having to clean or deoxidize the surface to be sealed as well as the risks of short-circuit related to run-out of the phases present.

The temperature Tc may be below about 300° C.

The first and/or second sealing material may be a eutectic alloy.

In this case, the production of a sealing material which is a eutectic alloy may be obtained at least by implementing several successive depositions of materials intended to form the eutectic alloy, and at least one thermal treatment of said materials intended to form the eutectic alloy at a temperature below the respective melting temperatures of said materials intended to form the eutectic alloy, homogenizing said materials.

The first sealing material may be a gold- and tin-based alloy, the second sealing material possibly being gold. The choice of such sealing materials is interesting for the following reasons:
the sealing heat balance is relatively low, for example around 270° C. for about 20 minutes,
the real pressure to be applied to the surfaces to be adhered is relatively low, for example equal to about 5 MPa,
no particular precaution needs to be taken into account concerning any roughness of the surfaces to be sealed,
it is not necessary to deoxidize or clean the surfaces to be sealed.

The securing step may be carried out at a temperature greater than about 200° C. or 230° C., and/or may include a compression of the first sealing material against the second sealing material at a pressure greater than about 10⁶ Pa (corresponding to the pressure obtained on the surface effectively adhered). This temperature may be chosen to be as high as possible, while remaining compatible with the technology and application used, in order to promote the interdiffusion of the components of each sealing material, thereby minimizing the sealing duration, given that the sealing materials, or one of the sealing materials, rapidly become malleable.

The thickness of the first and/or second sealing material produced may be between about 100 nm and several tens of micrometers, for example between about 100 nm and 50 μm. Larger thicknesses may also be considered depending on the bulk constraints to be respected.

During the production of the first sealing material and/or the second sealing material, one or more phases, different from the phase(s) of the first and/or second sealing material, may form on the face of the first and/or second element, the first and/or second sealing material then being arranged on said phase(s). This case will be particularly advantageous when the sealing materials are gold and AuSn. Thus, the AuSn is stabilized by a thermal treatment (TTH) in order to avoid the evolution of the alloy over time (Au/Sn interdiffusion at ambient temperature) and form phases close to the thermodynamic balance allowing sealing, and avoid oxidization of the tin. Furthermore, this or these intermediate phases may also serve to absorb the deformations caused during temperature cycles during the implementation steps before sealing.

The first sealing material may have a different hardness from the hardness of the second sealing material. A hardness difference between the two sealing materials makes it possible to produce, during the thermocompression, a deformation of the least hard sealing material, allowing the least hard sealing material to fit the shape of the hardest sealing material.

The first and/or second sealing material may have a melting temperature below around 400° C.

The securing step may be carried out in a vacuum, thereby making it possible to avoid trapping gases, for example in the sealing materials, during the sealing method.

Each element may have a substrate, or support. The method is in particular applicable to all types of substrates needing to be assembled by a metal connection, the latter being able to define cavities as in the particular case of MEMS packaging (on the scale of a wafer on which several electronic chips are made or on the scale of one electronic chip). This will be the case when one or more microcomponents are encapsulated, one of the two substrates including the microcomponent(s) at the face intended to receive one of the sealing materials, and the other of the two substrates serving as a cover for this or these microcomponents.

The sealing materials may be produced, on the elements, in the form of layers or cords, or may be made using any pattern. The production of the sealing materials in the form of cords may in particular be used during the encapsulation of the microcomponents, the cords of sealing materials being made on the periphery of the encapsulating cavity or cavities.

### BRIEF DESCRIPTION OF THE DRAWINGS

The present invention will be better understood upon reading the description of embodiments provided purely for information and non-limitingly in reference to the appended drawings, in which:

FIGS. 1A to 1C diagrammatically show the steps of a sealing method according to one particular embodiment,

FIGS. 2A to 2D show the steps of a sealing method according to another specific embodiment.

Identical, similar, or equivalent parts of the different figures described below bear the same numerical references so as to facilitate the transition from one figure to another.

The different parts shown in the figures are not necessarily shown using a uniform scale, to make the figures more legible.

The different possibilities (alternatives and embodiments) must be understood as not being mutually exclusive and can be combined with each other.

### DETAILED DESCRIPTION OF THE INVENTION

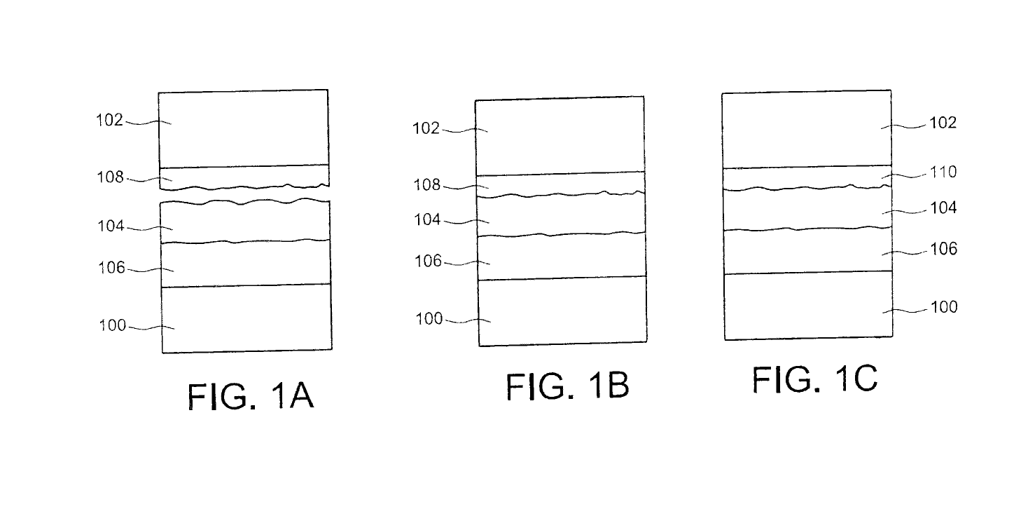

Reference is first made to FIGS. 1A to 1C, which diagrammatically show the steps of a method for sealing two substrates 100 and 102 according to a particular embodiment.

As shown in FIG. 1A, a layer 104 of a first sealing material is made on a face of the first substrate 100. Although it is possible to make the layer 104 directly against the first substrate 100, it is also possible, as shown in FIG. 1A, for the production of the layer 104 to lead to the formation of one or more other phases 106 on the first substrate 100.

A layer 108 of a second sealing material is made on a face of the second substrate 102. The second sealing material is of a different nature than the first sealing material. The two sealing materials are chosen such that the components of the phase(s) of these materials are able to react together to form at least one other phase.

As shown in FIG. 1B, the layer 104 is then put in contact and pressure against the layer 108. This assembly is done at a temperature Tc below the melting temperatures of the sealing materials forming the layers 104 and 108, and for example below about 300° C. A particular thermocompression is thus done during which an interdiffusion of the components of the sealing materials of the layers 104 and 108 occurs. This interdiffusion forms one or more other phases 110 that thus seal the substrates 100 and 102 together (FIG. 1C). Depending on the initial thicknesses of the layers of sealing materials 104 and 108, the phase(s) 110 may be formed by all of the components of the two layers 104 and 108, or by all of the components of one of the layers 104 or 108 and some of the components of the other layer, 108 or 104, respectively, or by some of the components of the two layers 104 and 108.

The temperature Tc at which the thermocompression is done is chosen to be close to the melting temperature of the first sealing material (that of the layer 104) in order to “soften” the layer 104, i.e. to reduce the hardness of this layer 104. Thus, the mechanical pressure applied between the substrate 100 and the substrate 102 during sealing allows a slight deformation of the layer 104 to ultimately ensure close contact between the two surfaces to be adhered while promoting the reaction between the components of the first and second sealing materials responsible for the adhesion between the substrates 100 and 102. Furthermore, this softening makes it possible to seal surfaces having a substantial roughness without needing to be worried, i.e. without it being necessary for example to perform a planarization to eliminate these roughnesses, which is not the case when a standard thermocompression is done.

Advantageously, it will be possible to choose the first and second sealing materials such that they have a different hardness, which makes it possible to deform the sealing material including the least hard phase to fit the surface of the hardest phase of the other sealing material.

Furthermore, placing the substrates 100, 102 in contact via layers of sealing materials 104 and 108 will be done in a vacuum to avoid trapping gases during the sealing process.

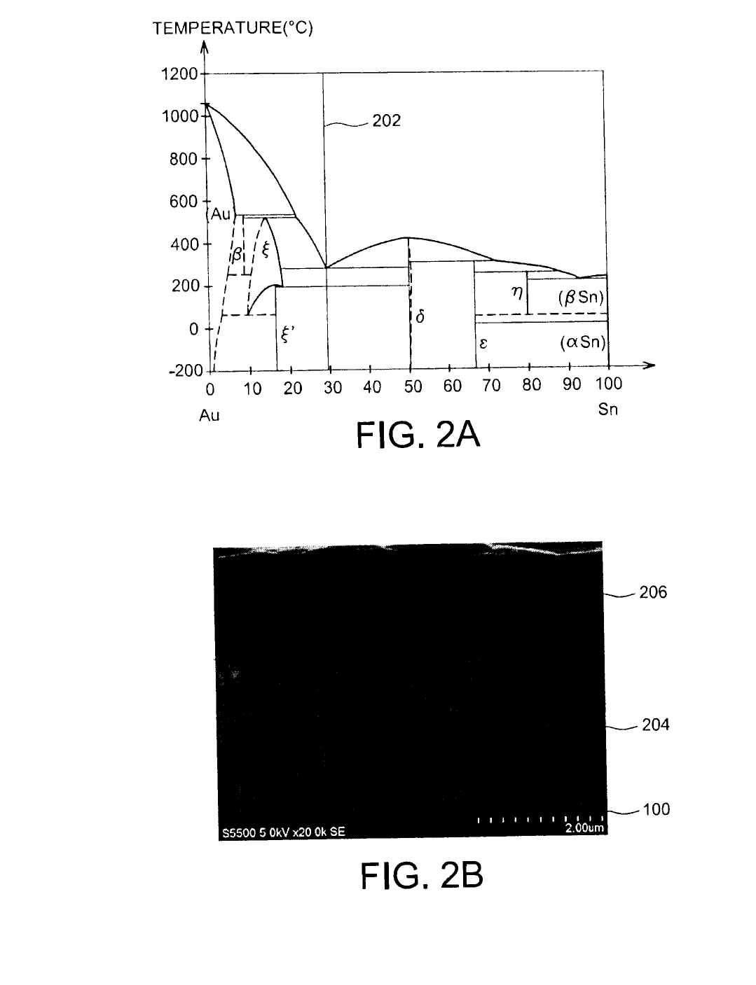

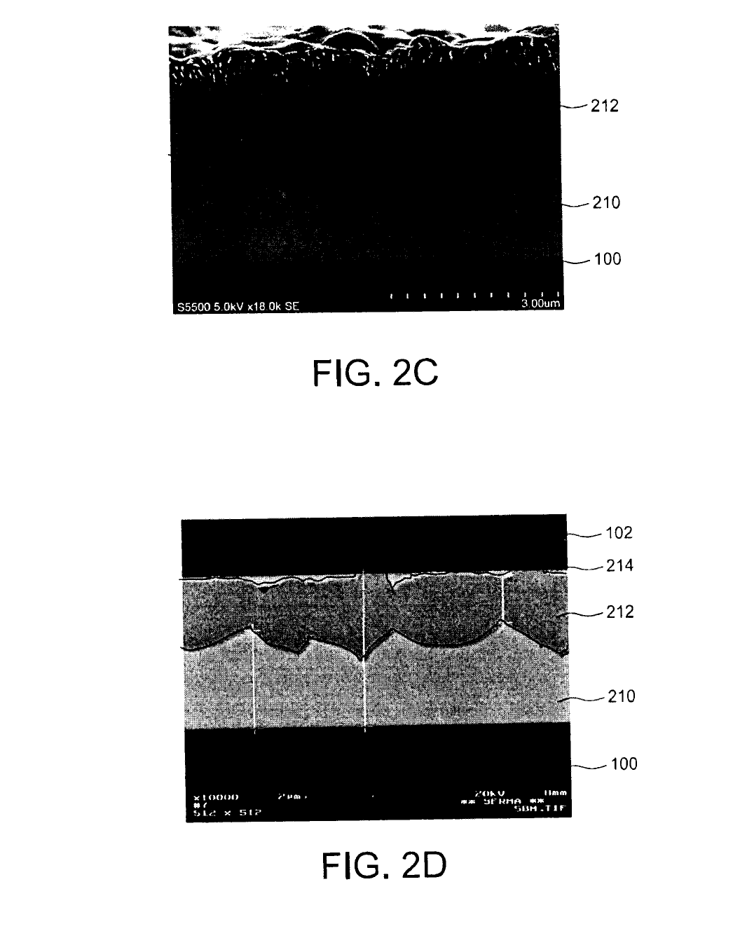

One particular embodiment of the sealing method previously described will now be described in connection with FIGS. 2A to 2D.

In this embodiment, the first sealing material of the layer 104 is a eutectic alloy of the AuSn type. The phase diagram of such an alloy is shown in FIG. 2A. In this embodiment, the alloy of the first sealing material will be formed by about 29 atomic percent tin and the rest gold.

The vertical line 202 shown in the phase diagram corresponds to the eutectic alloy used here. It emerges from this phase diagram that the eutectic alloy considered here is composed, at ambient temperature, of Au₅Sn (ξ′) and AuSn (δ) phases, the melting temperature being equal to about 278° C.

This eutectic alloy, intended to form the first sealing material, is obtained by first producing a first gold deposition, forming a first layer 204 on the first substrate 100, then a second tin deposition, forming a second layer 206, by electrolysis, for example through a mask whereof the pattern corresponds to cords, directly on the first substrate 100 in the desired proportions (29% Sn and 71% Au). Unlike the example of FIG. 1A, no phase is inserted between the layer composed of the first sealing material and the first substrate 100 (see FIG. 2B).

A thermal treatment is then done, for example at a temperature substantially equal to 200° C. and for a period of about 4 hours, in order to homogenize the depositions 204 and 206 previously done. As shown in FIG. 2C, one obtains, on the substrate 100, a layer 210 composed of the phase E arranged against the substrate 100 and a layer 212 composed of AuSn (δ)+Au₅Sn (ξ′) phases on the surface of the layer 210. The layers 210, 212 here have a thickness equal to about 4.5 μm and for example have a roughness between about 70 nm and 100 nm measured in AFM 5×5 μm². The layer 212 here therefore forms the first sealing material.

Parallel to the preparation of the first substrate 100, a gold-based layer with a thickness equal to about 100 nm, corresponding to the layer 108 composed of the second sealing material, shown in FIG. 1A, is deposited on the second substrate 102.

This gold layer here has a roughness equal to about 1.5 nm measured in AFM 5×5 μm².

One thus proceeds with the thermocompression of the two substrates 100 and 102 via layers of sealing materials. In this particular embodiment, the sealing temperature is chosen to be close to the melting temperature of the eutectic alloy forming the layer 212 (279° C.), and for example equal to about 270° C. A pressure equal to about 50 bars is applied between the two substrates 100 and 102 (pressure obtained on the surface effectively adhered), for a period equal to about 20 minutes from the time when the temperature reaches 270° C.

The sealing between the substrates 100 and 102 occurs after the reaction of the gold (second sealing material) with the AuSn (δ)+Au₅Sn (ξ′) layer 212, which forms the ξ or Au₅Sn phase, referenced 214 in FIG. 2D and corresponding to phase 110 shown in FIG. 1C. This reaction is favored by a large contact surface between the sealing materials owing to the softening of the phase 212.

Although in this embodiment the layer of gold serving as second sealing material has been chosen to be relatively thin (thickness equal to about 100 nm), it is also possible for this layer to have a thickness in the vicinity of 1 or several micrometers. The choice of thicknesses of the sealing materials will depend on the desired spacing between the substrates to be assembled, while being sufficient for interdiffusion to occur during the sealing between the components of the phases of sealing materials.

1.-12. (canceled)

13. A sealing method between at least two elements, comprising:
producing at least one first sealing material on at least one face of a first element of said two elements;
producing at least one second sealing material, different from the first sealing material, on at least one face of a second element of said two elements;
securing said two elements together by thermocompression of the sealing materials against each other at a temperature Tc below melting temperatures of the first and second sealing materials,
wherein the first sealing material has a phase that reacts with a phase of the second sealing material by interdiffusion of components of the respective phases of the first and second sealing materials during the securing step, and
wherein the respective phases of the first and second sealing materials react together and form at least one solid phase having a melting temperature that is higher than the temperature Tc, and
wherein the first or second sealing material is an eutectic alloy obtained at least by implementing several successive depositions of materials intended to form the eutectic alloy, and at least one thermal treatment of said materials intended to form the eutectic alloy at a temperature below the respective melting temperatures of said materials intended to form the eutectic alloy, said successive depositions and said at least one thermal treatment being implemented before the securing of said two elements by thermocompression.

14. The sealing method according to claim 13, wherein the temperature Tc is less than about 300° C.

15. The sealing method according to claim 13, wherein the first sealing material is a gold- and tin-based alloy, the second sealing material being gold.

16. The sealing method according to claim 13, wherein the securing step is carried out at a temperature greater than about 200° C. or includes a compression of the first sealing material against the second sealing material at a pressure greater than about 10⁶ Pa.

17. The sealing method according to claim 13, wherein the thickness of the first or second sealing material is between about 100 nm and 50 μm.

18. The sealing method according to claim 13, wherein, during the production of the first sealing material or the second sealing material, one or more phases, different from the phase of the first or the phase of second sealing material, form on the face of the first or second element, the first or second sealing material then being arranged on said phases of the first or second sealing material.

19. The sealing method according to claim 13, wherein the first sealing material have a different hardness from the hardness of the second sealing material.

20. The sealing method according to claim 13, wherein the securing step is carried out in a vacuum.

21. The sealing method according to claim 13, wherein each element includes a substrate.

22. The sealing method according to claim 13, wherein the sealing materials are produced, on the elements, in the form of layers or cords.
